(19) United States
(12) Patent Application Publication
(10) Pub. No.: US 2014/0128124 A1
(43) Pub. Date: May 8, 2014

(54) APPARATUS FOR RECEIVING AND/OR TRANSMITTING DATA

(71) Applicant: Satcom Technology B.V., Schiphol (NL)

(72) Inventors: David Geen, Schiphol (NL); Ron Schiltmans, Schiphol (NL)

(73) Assignee: Satcom Technology B.V., Schiphol (NL)

(21) Appl. No.: 14/074,328

(22) Filed: Nov. 7, 2013

(30) Foreign Application Priority Data
Nov. 8, 2012 (GB) 1220149.7

(51) Int. Cl. H04B 1/40

(52) U.S. Cl. CPC H04B 1/401
USPC 455/552.1

(57) ABSTRACT

Apparatus is provided for the transmission and/or reception of data within a predetermined frequency bandwidth. The operating bandwidth extends into a predetermined bandwidth range designated for a first use and a predetermined bandwidth range designated for a second use.

### RELATED APPLICATIONS

This application claims priority to GB1220149.7 filed Nov. 8, 2012, herein incorporated by reference in its entirety.

The invention to which this application relates is apparatus which allows data to be transmitted and/or received and, in particular, with regard to the ability to transmit and receive data via a satellite transmission system.

It is well known to be able to transmit and receive data via satellite transmission systems and there are many different forms of use of the same. This application is primarily directed towards the ability and requirement to transmit and receive data when the location at which the same is to be performed changes and indeed may not be known in advance. Such uses, could, for example, be use by nomadic personnel, or other commercial uses in which the movement of personnel is common and there is a need for reception and/or transmission of data signals to be performed at different geographical locations via either different spot beams from a given satellite or different satellites located at different orbital slots, each of which may be transmitting and receiving at different frequencies and with different polarisation schemes.

Commonly, the available frequency bandwidth which can be used for the transmission of data is in the range of 28-30 GHz for civil operations and 30-31 GHz for non-civil operations and there is no cross over between the same. Similar is applicable for the reception of data in the range 18.2-21.2 GHz. While these limitations are found to be acceptable for civil operations where the location of use tends to be more likely to be at a fixed location, in non-civil uses where the location of use can change and can often be in relatively geographically remote areas there are occasions where the non-civil bandwidth is not available and hence conventionally, the apparatus which the personnel may have may not be usable.

A further problem which is experienced is that data transfer can be conducted using different polarisation schemes at different geographical locations such that, for example, at a first geographical location data may be transmitted in Right Hand Circular Polarisation (RHCP) and received in Left Hand Circular Polarisation (LHCP), whereas in other geographical locations data may be transmitted in LHCP and received in RHCP. Typically the polarisation scheme which is used is dependent upon the particular satellite system configuration used at the particular location. While the selection of the appropriate polarisation sense of the antenna to match the satellite polarisation scheme can be relatively easily done when the receiving and/or transmitting apparatus is provided at a fixed location and at which the polarisation is consistent, it does represent a problem when the apparatus is to be moved between different geographical locations for which the polarisation scheme may change. If the apparatus is only capable of communicating using one particular scheme this means that the apparatus is only capable of being operated in certain geographical locations which is largely unacceptable for transportable apparatus. The current alternative is to provide apparatus which has the capability to change polarisation sense to match the satellite polarisation scheme but this requires the user to be sufficiently skilled to determine the polarisation scheme applicable to that particular geographical region and subsequently manually configure the ground apparatus to operate with the corresponding polarisation sense. However this is time consuming and requires the operator of the apparatus to understand what is required in order to be able to receive and transmit data successfully and then perform the configuration accordingly.

The aim of the present invention is therefore to provide apparatus which is capable of receiving and/or transmitting data signals via a satellite transmission system and which apparatus is configurable in a number of different formats in order to render the scope for operation of the same at different geographical locations and for use with different satellites to be increased. A further aim is to provide the apparatus in a form which allows the change in configuration to be achieved reliably and efficiently.

In a first aspect of the invention there is provided apparatus for the transmission and/or reception of data within a predetermined frequency bandwidth wherein said operating bandwidth extends into a predetermined bandwidth range designated for a first use and a predetermined bandwidth range for a second use.

Typically the first use is for a civil use and the second use is for a non-civil use.

In one embodiment the respective terminal transmitting frequency bandwidth ranges are 28-30 GHz and 30-31 GHz and preferably the apparatus operates across the frequency bandwidth of 28-31 GHz.

In one embodiment the apparatus includes means for the reception and/or transmission and processing of data signals which are received and transmitted in a given polarisation sense to suit a given satellite polarisation scheme and means for the reception and/or transmission and processing of data signals which are received and transmitted in a different polarisation sense to suit a different satellite polarisation scheme.

In one embodiment the apparatus includes an antenna, a waveguide through which the data signals pass and processing means for selective operation in the processing of the data. Typically the passage of the data signals through the processing means is dependent upon the polarisation of the data signals.

In a first embodiment the switching of operation of the processing means both in terms of frequency of operation and sense of polarisation for the receipt and transmission of data signals is performed automatically. In another embodiment the switch is performed manually.

In one embodiment the apparatus is a Ka band transceiver.

In an alternative embodiment the apparatus is formed from a plurality of modules. Typically, in this embodiment, one of the modules as appropriate is connected to the incoming or outgoing stream of data signals as appropriate to allow the successful reception or transmission of the data signals at the geographical location of use.

Typically, the selective operation of the processing means with regard to the data signal polarisation sense and the processing of the same is controlled and selected automatically with no user interaction required

In one embodiment the control of the operation of the apparatus is undertaken with respect to one or more detected operating parameters of the apparatus, said parameters including any or any combination of; the detection of the polarisation of the received data signals; the identity of the particular geographical location at which the apparatus is to be used, the location of the satellite which is to be used for the reception or transmission of the data signals and/or the satellite system which is to be used.

In each case it should be noted that in accordance with the invention the user of the apparatus does not need to know the parameter values as the appropriate control functions are performed by the apparatus. This is contrary to the use of the conventional apparatus in which the user is required to know the value of at least some of the parameters and then manually configure the apparatus as appropriate which can be a problem especially when the apparatus is to be used in hostile environments where obtaining the parameter information may be difficult and/or the time required to make the reconfiguration is potentially dangerous.

In a further aspect of the invention there is provided apparatus for the reception and/or transmission of data signals over a known frequency or frequency band, said apparatus including a waveguide and processing means capable of receiving and/or transmitting data signals in different polarisation senses and wherein the selection of the polarisation sense to be used and the switching of the operation of the apparatus to transmit and/or receive the data in said polarisation sense is performed automatically by control means provided as part of the apparatus.

In one embodiment the apparatus control means includes means to detect and/or receive data relating to any or any combination of the parameters of, detecting the data which is being received at the time of commencing operation of the apparatus, the detection of the polarisation of the received data signals; the identity of the particular geographical location at which the apparatus is to be used, the location of the satellite which is to be used for the reception or transmission of the data signals and/or the satellite system which is to be used.

In a further aspect of the invention there is provided a method for deploying apparatus provided to receive and/or transmit data signals, said apparatus including an antenna, positioning means for the antenna, a waveguide and processing means selectively operable to receive and/or transmit data signals in the required polarisation sense, said method comprising the steps of, identifying any or any combination of the parameters of; the geographical location at which the apparatus is being used, the identity of the satellite via which the data signals are to be transmitted and/or received, the location of the satellite; and/or the polarisation of the data received upon initial deployment of the apparatus; adjusting the position of the antenna with reference to at least one of the detected parameters and selecting the operating mode of the processing means to receive and/or transmit data in the required polarisation sense.

In one embodiment the selection of the operating mode and/or positioning of the antenna is performed automatically.

In one embodiment the polarisation scheme that can be accommodated by the apparatus includes: 1. transmission on RHCP, reception on LHCP; 2. transmission on LHCP, reception on RHCP; 3. transmission on RHCP, reception on LHCP and 4. transmission on LHCP, reception on LHCP.

Specific embodiments of the invention are now described with reference to the accompanying figures; wherein

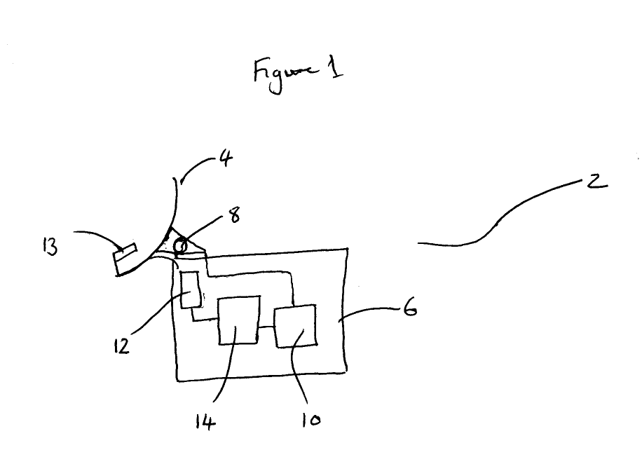

FIG. 1 illustrates schematically the components provided as part of the apparatus in accordance with one embodiment of the invention; and

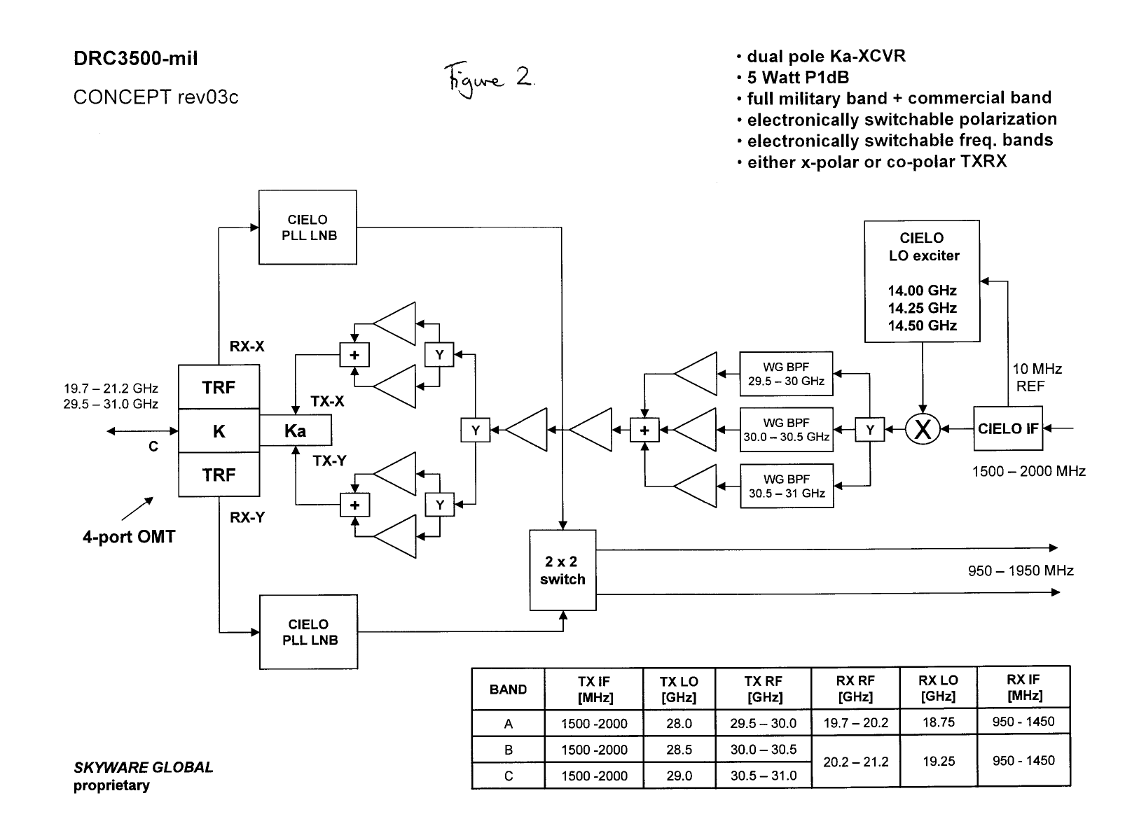

FIG. 2 illustrates an embodiment the processing means in accordance with one embodiment of the invention.

Referring firstly to FIG. 1 there is illustrated apparatus 2 for receiving and/or transmitting data signals. In accordance with the invention the apparatus is provided to be operable to transmit and/or received the data signals at a selected frequency within a relatively wide bandwidth, such as 28-31 GHz. Conventionally the 28-30 GHz bandwidth has been reserved for use for civil applications and the 30-31 GHz bandwidth has been reserved for use for non-civil applications and the conventional apparatus is typically restricted to be operable in relation to one or the other of the bandwidths. However it is found in practice, and especially from the non-civil viewpoint, that the restriction of apparatus to use only the 30-31 GHz bandwidth can lead to situations where the apparatus is not usable in certain geographical locations as the broadcast systems in use at those locations are not within the 30-31 GHz bandwidth. This therefore means that the conventional apparatus cannot be used and can this lead to potentially hazardous situations for the non-civil personnel who are unable to make contact with a remote location.

In accordance with the invention the apparatus is capable of operating over the wider bandwidth of 28-31 GHz to therefore allow all available satellite communication systems within the wider bandwidth to be available for selection and thereby increasing the opportunity for operation of the apparatus in differing geographical locations and with different available satellites.

The apparatus 2 includes an antenna 4 which is provided with position controlling means to allow the adjustment of the pointing angle of the antenna. Typically the adjustment is with regard to both elevation and azimuth and allows the antenna pointing angle to be adjusted to allow the same to optimally receive and/or transmit data from and to a particular satellite at a given location.

Preferably the position controlling means include drive means 8 which act on the locating bracket for the antenna so as to allow the automatic and powered adjustment of the position of the antenna 4 to that which is required. The selection of the required position is made by control means 10 provided in the apparatus which calculate the required position of the antenna 4, typically with regard to the geographical location of the apparatus at that time and/or the known location of the satellite or transponder which is identified as being most appropriate for use at the geographical location of the apparatus at that time.

Within the housing of the apparatus there are provided a waveguide 12 through which received data passes from the antenna and typically a Low Noise Block (LNB) 13 located intermediate the same.

The housing also includes processing means 14 which are provided to allow the processing of the received data signals and/or the data signals to be transmitted in a particular polarisation sense to suit the satellite polarisation scheme. In accordance with the invention the apparatus is capable of processing the data signals in both formats and the particular passage of the data signals through the processing means and the components of the same which are used is dependent upon the particular format of the data signals at that time.

Again the decision as to which polarisation sense and frequency band to use is made by the control means with regard to specific operating parameters and/or to the identification at the initial operation of the apparatus of the particular data signals which an be detected at the geographical location of use. Preferably, once the decision is made as to which polarity sense is to be used the apparatus will be switched to operate in the that format or configuration and the switching will occur automatically thereby avoiding the requirement for any user input which, in turn, means that the apparatus can be operated successfully by a relatively unskilled person.

It is envisaged that the geographical location of the apparatus will alter over the time of use and so the need for automatic and efficient switching of operation to allow optimum operation at each location of use is important. The processing configuration can be selected from one of a number of possible configurations and one example is shown in FIG. 2 and it is believed that this configuration is particularly of use with apparatus designed to be used in apparatus for land based purposes. For maritime or airborne apparatus the processing means may be provided by a series of modules which can selectively be used.

What is claimed:

1. Apparatus for the transmission and/or reception of data within a predetermined frequency bandwidth wherein said operating bandwidth extends into a predetermined bandwidth range designated for a first use and a predetermined bandwidth range for a second use.

2. Apparatus according to claim 1 wherein the first use is for a civil use and the second use is for a non-civil use.

3. Apparatus according to claim 1 wherein the respective terminal transmitting frequency bandwidth ranges are 28-30 GHz and 30-31 GHz.

4. Apparatus according to claim 3 wherein the apparatus operates across the frequency bandwidth of 28-31 GHz.

5. Apparatus according to claim 1 wherein the apparatus includes means for the reception and/or transmission and processing of data signals which are received and transmitted in a given polarisation sense to suit a given satellite polarisation scheme and means for the reception and/or transmission and processing of data signals which are received and transmitted in a different polarisation sense to suit a different satellite polarisation scheme.

6. Apparatus according to claim 1 wherein the apparatus includes an antenna, a waveguide through which the data signals pass and processing means for selective operation in the processing of the data.

7. Apparatus according to claim 6 wherein the passage of the data signals through the processing means is dependent upon the polarisation of the data signals.

8. Apparatus according to claim 1 wherein the switching of operation of the processing means in terms of frequency of operation and sense of polarisation for the receipt and transmission of data signals is performed automatically.

9. Apparatus according to claim 1 wherein the apparatus is formed from a plurality of modules including a module connected to the incoming or outgoing stream of data signals as appropriate to allow the reception and/or transmission of the data signals at the particular geographical location of use.

10. Apparatus according to claim 1 wherein the control of the operation of the apparatus is undertaken with respect to one or more detected operating parameters of the apparatus, said parameters including any, or any combination of; the detection of the polarisation of the received data signals; the identity of the particular geographical location at which the apparatus is to be used, the location of the satellite which is to be used for the reception or transmission of the data signals and/or the satellite system which is to be used.

11. Apparatus according to claim 10 wherein the apparatus can be utilised with knowledge of at least one of said parameter values at that instant of time.

12. Apparatus for the reception and/or transmission of data signals over a known frequency or frequency band, said apparatus including a waveguide and processing means capable of receiving and/or transmitting data signals in different polarisation senses and wherein the selection of the polarisation sense to be used and the switching of the operation of the apparatus to transmit and/or receive the data in said polarisation sense is performed automatically by control means provided as part of the apparatus.

13. Apparatus according to claim 12 wherein the apparatus control means includes means to detect and/or receive data relating to any, or any combination, of the parameters of, detecting the data which is being received at the time of commencing operation of the apparatus, the detection of the polarisation of the received data signals; the identity of the particular geographical location at which the apparatus is to be used, the location of the satellite which is to be used for the reception or transmission of the data signals and/or the satellite system which is to be used.

14. A method for deploying apparatus provided to receive and/or transmit data signals, said apparatus including an antenna, positioning means for the antenna, a waveguide and processing means selectively operable to receive and/or transmit data signals in the required polarisation sense, said method comprising the steps of, identifying any or any combination of the parameters of; the geographical location at which the apparatus is being used, the identity of the satellite via which the data signals are to be transmitted and/or received, the location of the satellite; and/or the polarisation of the data received upon initial deployment of the apparatus; adjusting the position of the antenna with reference to at least one of the detected parameters and selecting the operating mode of the processing means to receive and/or transmit data in the required polarisation sense.

15. A method according to claim 14 wherein the selection of the operating mode and/or positioning of the antenna is performed automatically.

16. A method according to claim 14 wherein the polarisation scheme that can be accommodated by the apparatus includes any or any combination of; transmission on RHCP, reception on LHCP; transmission on LHCP, reception on RHCP; transmission on RHCP, reception on LHCP and/or transmission on LHCP, reception on LHCP.
